(19) United States
(12) Patent Application Publication
(10) Pub. No.: US 2006/0181159 A1
(43) Pub. Date: Aug. 17, 2006

(54) Machine tool and arrangement for the throughflow collant

(76) Inventor: Joerg Dehde, Steinenbronn (DE)

Correspondence Address: Striker Striker & Stenby, 103 East Neck Road, Huntington, NY, 11743, US

(21) Appl. No.: 10/550,283

(22) PCT Filed: Sep. 24, 2004
(86) PCT No.: PCT/DE04/02130

§ 371 Date: Sep. 22, 2005

(30) Foreign Application Priority Data
Oct. 17, 2003 (DE) 10348396.9

(51) Int. Cl. E21B 17/22; E21B 19/18; H02K 5/24

(52) U.S. Cl. 310/51; 173/217; 310/52

(57) ABSTRACT

The invention is based on a power tool, in particular a handheld electric power tool, having a housing (10) with a coolant duct arrangement, having through openings (14), for a cooling medium for cooling at least one motor located in the housing (10).

It is proposed that the through openings (14) each have cross-sectional areas in the range from 0.15 mm² to 10 mm². A coolant duct arrangement is also proposed.

### PRIOR ART

The invention is based on a power tool and a coolant duct arrangement as generically defined by the preambles to the independent claims.

It is known to provide ventilation slits in power tools for the passage of air through them, for delivering and removing cooling air for cooling an electric motor located in the housing. The noise from the air flow can be perceived by the user as irritating. Reducing the noise can be done for instance by enlarging the surface provided with ventilation slits. However, the ventilation slits weaken the stability of the housing, so that the surface area must be limited for reasons of stability, and protection against touching open electrical or moving parts in the housing must also be assured.

### ADVANTAGES OF THE INVENTION

The invention is based on a power tool, in particular a handheld electric power tool, having a housing with a coolant duct arrangement, having through openings, for a cooling medium for cooling at least one motor located in the housing.

It is proposed that the through openings each have cross-sectional areas in the range from 0.15 mm² to 10 mm². Preferably, the cross-sectional area is below 3.5 mm², and especially preferably is about 0.8 mm². The smallest possible, tightly packed through openings are favorable. For a housing, a substantially larger area can be provided with the through openings than is possible with conventional ventilation slits, and the housing stability remains substantially unaffected. Despite enlarging the area, touch protection is preserved and even improved, since the diameters of the through openings are markedly less than the openings of conventional ventilation slits. Moreover, enlarging the area to both sides of the through openings practically automatically creates sufficient room for expansion for a coolant flow, in particular an air flow. The largest possible expansion room is advantageous for the sake of low noise. It is favorable for the through openings to be located in a perforation structure with through openings arranged in columns and rows.

If the through openings are provided at at least one coolant outlet, this can prevent dust eddies from forming in the work region and/or can prevent the emerging flow from being irritating to a user.

If the through openings have a depth which is equivalent to at least one crosswise length of the through openings, an especially favorable geometry for noise reduction exists. If a through opening is shaped elliptically, the crosswise length can for instance be equal to the long or short semiaxis; with a round through opening, the crosswise length is equivalent to the diameter. It is favorable to select the depth as at least twice as great as the size of the crosswise length.

If the through openings are located in a plate which is joined to the housing, they can be adapted individually to a device and optimized for that use. The plate may be joined to the housing integrally or as a separate part. Optionally, the plate is replaceable. The plate may for instance be made of plastic and joined to a plastic or metal housing.

If the through openings are embodied as round, the result is a structure that is easy to manufacture and can be produced for instance by conventional casting or injection molding methods.

If elements in a flow path inside the housing are provided with rounded edges and/or are embedded in at least some regions in a casting composition, streamlined edges and regions can be created that cause only little noise. Sharp edges are advantageously avoided. It is favorable for struts of a switch that are located in the housing to be embedded in a casting composition.

The invention is also based on a coolant duct arrangement for cooling a body located in a housing.

It is proposed that the through openings each have cross-sectional areas in the range from 0.15 mm² to 10 mm². Preferably, the cross-sectional area is below 3.5 mm², and especially preferably is about 0.8 mm². Hence a reduction in the flow speed of a coolant flow that passes through the through openings, which is advantageous for reducing noise, and a reduction in the size of flow eddies are attainable. Reducing the flow speed can be attained especially by means of a large-area disposition of preferably round through openings with small cross-sectional areas. By enlarging the area that has the through openings, with substantially the same diameters and spacings of the through openings, the flow speed can be reduced. For suitably small diameters of approximately 0.5 mm to approximately 3 mm, the eddy size can especially advantageously be reduced, and as the flow passes through the through openings, smaller detachment eddies of the flow are formed. Preferably, the diameter is less than 2 mm, and especially preferably is about 1 mm. The noise produced is greatly affected by the flow speed and the eddy size. The lower the flow speed and the smaller the eddy size, the less noise is produced. This is further improved by means of preferably slight spacings of the through openings. Simultaneously, in contrast to ventilation slits, the mechanical stability of the arrangement with through openings is preserved substantially unchanged, even if the number of the through openings and hence the total area are greatly increased. Despite the large number of through openings, sound especially favorably reflected in the arrangement by closely spaced through openings with small cross-sectional areas and with ribs located between them. As the flow passes through the many through openings, a substantially nondirectional flow furthermore develops. Eddies are thus easily avoided.

With a large-area arrangement, a high coolant throughput, with low flow speed and correspondingly reduced noise, is made possible. After passing through the through openings, the coolant flow is substantially nondirectional and widely fanned out, so that the flow can be distributed around the perforation structure, resulting in a pronounced noise reduction. Moreover, with the nondirectional flow, particularly in an outlet region, dust for instance is prevented from becoming turbulent. The perforation structure is easy to manufacture and can be designed individually for various uses in terms of its contour, size, and the dimensions of the through openings.

If the through openings have a depth which is equivalent to at least one crosswise length of the through openings, the result is a flow resistance that causes only small detachment eddies and in which, at a low flow speed, a high coolant throughput is possible. The through openings can be shaped arbitrarily, for instance being round, elliptical or polygonal. With an elliptically shaped through opening, the crosswise length can correspond for instance to the long or the short semiaxis; with a round through opening, the crosswise length is equivalent to the diameter. In a preferred round through opening, the diameter is favorably between 0.5 mm and 3 mm, and especially preferably is about 1 mm. It is advantageous to select as small a diameter or crosswise length as possible. The smaller they are, the less noise is produced.

If a rib width between two through openings closest to one another is equivalent at most to one crosswise length of the through openings, then the tightest possible arrangement of through openings can be attained. Preferably, the rib width is as slight as possible yet still large enough that an adequate mechanical stability of the arrangement is assured. One skilled in the art will adapt the crosswise length, rib width, and depth of the through openings, and optionally a material in which through openings are located, appropriately to one another.

If the through openings are located in columns and/or rows of equal rib width, the result is a tightly packed arrangement with a high coolant throughput.

If the through openings are combined in groups, which are spaced apart substantially equally in columns and/or in rows, the flow can be varied in order to be adapted to a location where the arrangement is used.

Preferably, the through openings within the group have different diameters and/or rib widths. Thus a purposeful influence can be exerted on the flow.

If the through openings are embodied substantially cylindrically, an especially advantageous noise reduction results. This geometry is easily manufactured. Alternatively, the through openings may be embodied conically. An inclination angle of a side wall is preferably less than 10θ, for instance approximately 8θ.

### DRAWING

Further advantages will become apparent from the ensuing drawing description. In the drawing, exemplary embodiments of the invention are shown. The drawing, description and claims include numerous characteristics in combination. One skilled in the art will expediently consider the characteristics individually as well and put them together to make useful further combinations.

Shown are:

FIG. 1, a preferred delta grinder with a perforation structure;

FIG. 2, (a) a preferred perforation structure, (b) an enlargement of the perforation structure, (c) a section through a plurality of cylindrically embodied through openings, and (d) a section through a plurality of conically embodied through openings;

FIG. 3, a view in the housing interior, with elements embedded in a casting composition.

### DESCRIPTION OF THE EXEMPLARY EMBODIMENTS

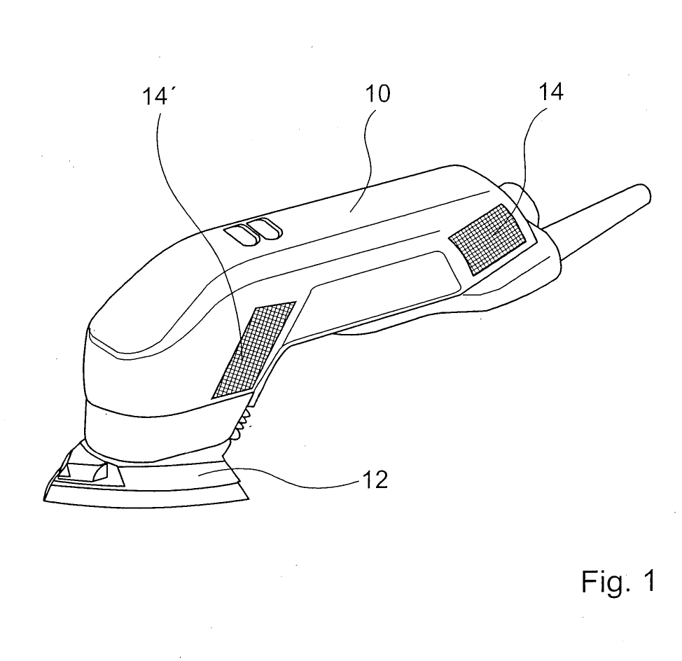

The invention is especially suitable for air-cooled power tools, especially handheld electric power tools. FIG. 1 shows a preferred power tool in a form of Delta grinder, with a coolant duct arrangement according to the invention that has through openings 14, 14′ for coolant, for cooling a motor, in particular an electric motor, which is located in a housing 10 and by which a tool insert 12 can be driven.

A plurality of small, closely spaced through openings 14, 14′, preferably round in plan view, are separated by ribs 22. As the preferred coolant, air is for instance aspirated through a fan, not shown, in the housing 10. The through openings 14′ are favorably located at at least one air outlet region.

The through openings 14, 14′ are preferably each located in a plate that is joined to the housing 10. The plate can be glued, welded, clamped, or screwed. The plate may also be integral with the housing 10.

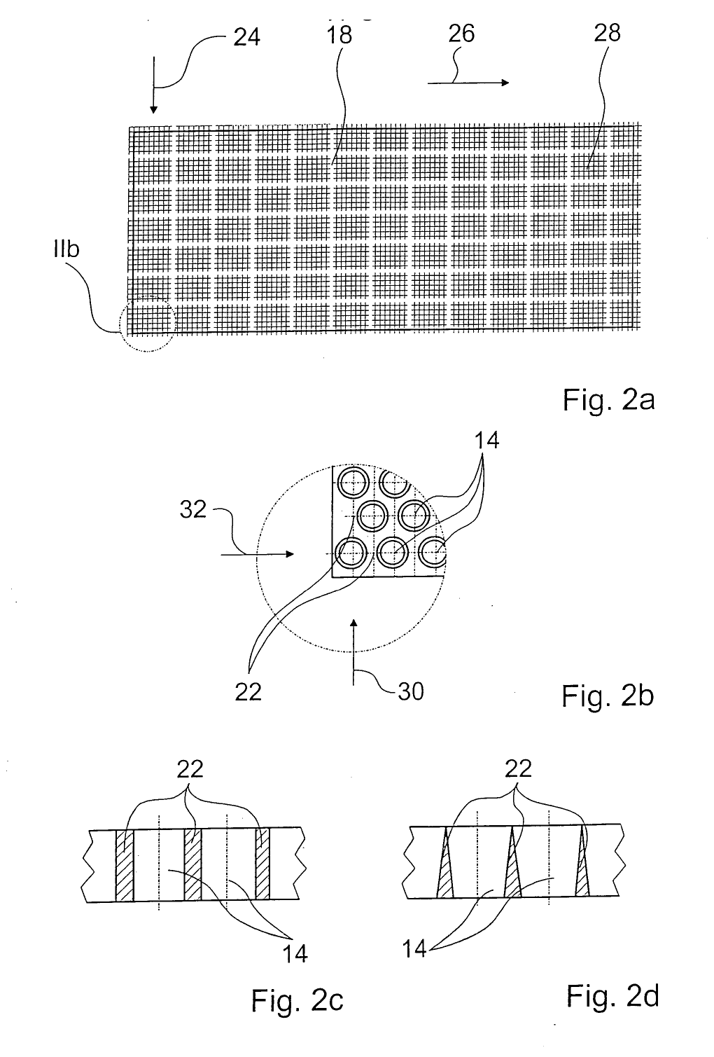

As can be seen from FIG. 2, the through openings 14, in a preferred embodied, form a gridlike perforation structure 18 (FIG. 2a). The through openings 14 are favorably arranged in columns 24 and rows 26. An irregular arrangement, for instance with a statistical distribution, may also be provided. In a first row 26, through openings 14 are located next to one another, with equal spacings. In the next row 26, the through openings 14 are located above the ribs 22 of the lower row 26. This makes the tightest possible arrangement of through openings 14 possible. Optionally, the through openings 14 in different rows 26 may also be located directly one above the other. A random or statistical arrangement of through openings 14 is also possible.

In the exemplary embodiment shown, the through openings 14 are combined into groups 28, located at essentially regular spacings. Within one group 28, the through openings 14, with different diameters, may for instance be located regularly. For instance, through openings 14 within one row 26 of the group 28 may be embodied identically, but the next rows 26 may each have different diameters. Alternatively, within one, group column 30 and/or group row 32, the diameter may vary, and for instance may be at a maximum in the middle region of the group 28.

FIG. 2b shows an enlargement of a peripheral region of an arrangement with through openings 14. Preferably, the through openings 14 are embodied cylindrically, as shown in FIG. 2b. This has a major effect on noise reduction. Favorably, a depth of the through openings 14 is equivalent to at least the diameter of the through openings 14. With an especially preferred diameter of approximately 1 mm, or a cross-sectional area of approximately 3 mm², a depth of approximately 2 mm is favorable.

An alternative conical embodiment of the through openings 14 is shown in FIG. 2c, with a relatively slight angle of inclination of the walls of less than 10θ.

It is expedient to locate the through openings 14 on the housing 10, and/or to design their area, in such a way that components that project noise, such as a bearing or a gear space, are partitioned off by a closed region of the housing 10.

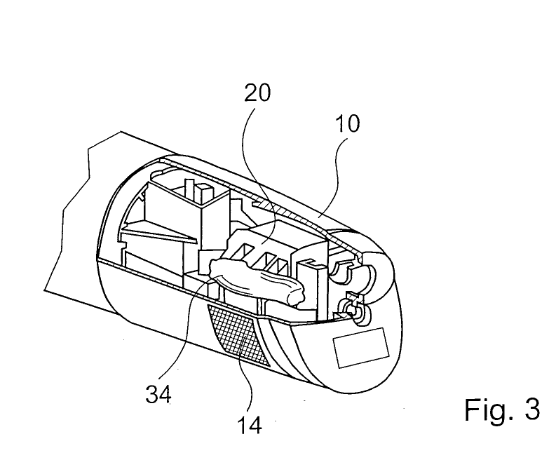

To improve the noise reduction, additional provisions may be made in the flow path inside the housing 10. This is shown in FIG. 3. Elements 20 located in the flow path between a coolant inlet and a coolant outlet are favorably provided with rounded edges. Struts, for instance of a switch, in the flow path are potted in a casting composition 34. Sharp edges in the flow path are preferably avoided.

A diffusor may also be provided, which influences coolant flow in such a way that the flow is as nondirectional as possible. Moreover, a fan optimized for noise reduction may be used for aspirating the coolant.

### LIST OF REFERENCE NUMERALS

10 Housing
12 Tool insert
14 Through opening
18 Perforation structure
20 Element
22 Rib
24 Column
26 Row
28 Group
30 Group column
32 Group row
34 Casting composition

1. A power tool, in particular a handheld electric power tool, having a housing (10) with a coolant duct arrangement, having through openings (14), for a cooling medium for cooling at least one motor located in the housing (10), wherein the through openings (14) each have cross-sectional areas in the range from 0.15 mm² to 10 mm².

2. The power tool according to claim 1,
wherein the through openings (14) are provided at at least one coolant outlet.

3. The power tool according to claim 1 or 2,
wherein the through openings (14) are located in a plate which is joined to the housing (10).

4. The power tool according to one of the foregoing claims,
wherein the through openings (14) have a depth which is equivalent to at least one crosswise length of the through openings (14).

5. The power tool according to one of the foregoing claims,
wherein the through openings (14) are embodied as round.

6. The power tool according to one of the foregoing claims,
wherein elements (20) in a flow path inside the housing (10) are provided with rounded edges and/or are embedded in at least some regions in a casting composition (34).

7. A coolant duct arrangement having through openings (14) for a coolant, in particular for a power tool,
wherein the through openings (14) each have cross-sectional areas in the range from 0.15 mm² to 10 mm².

8. The coolant duct arrangement according to claim 7,
wherein the through openings (14) have a perforation structure (18), with through openings (14) located in columns (24) and rows (26).

9. The coolant duct arrangement according to claim 7 or 8,
wherein the through openings (14) have a depth which is equivalent to at least one crosswise length of the through openings (14).

10. The coolant duct arrangement according to one of claims 7 through 9,
wherein a rib width between two through openings (14) closest to one another is equivalent at most to one crosswise length of the through openings (14).

11. The coolant duct arrangement according to one of claims 7 through 10,
wherein the through openings (14) are located in columns (24) and/or rows (26) of equal rib width.

12. The coolant duct arrangement according to one of claims 8 through 11,
wherein the through openings (14) are combined in groups (28), which are spaced apart substantially equally in columns and/or in rows.

13. The coolant duct arrangement according to claim 12,
wherein the through openings (14) within the groups (28) have different diameters and/or rib widths.

14. The coolant duct arrangement according to one of claims 7 through 13,
wherein the through openings (14) are embodied substantially cylindrically.
